(19) United States
(12) Patent Application Publication
(10) Pub. No.: US 2026/0266004 A1
(43) Pub. Date: Sep. 10, 2026

(54) METHOD FOR DETERMINING AN ASSUMED MOTION PATH TRAVELED BY A GROUND MILLING MACHINE, AND GROUND MILLING MACHINE

(71) Applicant: BOMAG GMBH, Boppard (DE)

(72) Inventor: Niels LAUGWITZ, Boppard (DE)

(21) Appl. No.: 19/539,237

(22) Filed: Feb. 13, 2026

(30) Foreign Application Priority Data
Feb. 17, 2025 (DE) 10 2025 105 860.1

(51) Int. Cl. E01C 23/088; E01C 23/12; G01S 19/24; G01S 19/41; G01S 19/48

(52) U.S. Cl. CPC E01C 23/088; E01C 23/127; G01S 19/24; G01S 19/41; G01S 19/48

(57) ABSTRACT

A method for determining an assumed motion path traveled by a ground milling machine, the method comprising determining an assumed motion path taking into account GNSS position data sets and local position data sets by an evaluation device. A ground milling machine having a GNSS signal receiving device and a local motion detection sensor device and having an evaluation device for carrying out the method.

### FIELD

The invention relates to a method for determining an assumed motion path traveled by a ground milling machine and a ground milling machine.

### BACKGROUND

Milling machines, in particular of the road cold milling machine type, are typically used to mill an existing road surface to a desired milling depth with the aid of a milling device, typically comprising a drum-shaped milling drum fitted with milling chisels on its outer surface, which engages the underlying ground during milling operation while rotating about a rotation axis running horizontally and transversely to the working direction. In the context of this milling work, it may be of interest to determine the motion path covered, in particular milled, by the ground milling machine during milling operation in order to be able to use this information for billing and/or documentation purposes, for example, and/or to make it available for construction machinery used downstream on the respective road construction site in the work process of the ground milling machine, such as a road paver for laying an asphalt mat.

It is known from DE 10 2022 133 913 A1 to add a quality feature to global navigation satellite system (GNSS) position data with the aid of a GNSS evaluation variable acquisition device. The document also describes the use of a mobile radio evaluation device. Based on this data, a spatial mobile radio telemetry data set is then to be transmitted to a cloud memory. If there are disruptions to the radio connection to the GNSS satellites, for example due to local shadowing, there is an increased probability that the necessary data transmission connection to the cloud memory will also no longer be available. During these operating phases, it is not possible to determine substitute values on the machine itself, which can lead to inaccuracies in the final result.

### SUMMARY

Against this background, the object of the invention is to provide an alternative way of documenting the motion path of a ground milling machine, in particular during milling operation, using a GNSS signal receiving device.

The object is achieved with a method for determining an assumed motion path traveled by a milling machine and with a ground milling machine according to the independent claims. Preferred embodiments are cited in the dependent claims.

The present method relates to a ground milling machine, in particular a self-propelled ground milling machine. Such ground milling machines may comprise a machine frame supported by travel units, a milling device mounted on the machine frame and a drive unit, such as an internal combustion engine and/or electric motor. The drive unit may be configured to provide the drive energy required for traveling and working or milling operation of the ground milling machine. Accordingly, the ground milling machine may be a self-propelled ground milling machine. The travel units may be connected to the machine frame via one or more lifting devices, so that the machine frame, and with it the milling device usually mounted on it, can be adjusted vertically, for example to set a milling depth. The ground milling machine may also include an operator platform from which the ground milling machine can be operated by an operator. Additionally or alternatively, the ground milling machine may comprise one or more transport devices, in particular in the form of conveyor belts, for transporting the milled material produced during a milling operation to a discharge point. Such a ground milling machine is disclosed, for example, in DE 10 2023 203 188 A1.

The method according to the invention for determining an assumed motion path traveled by a ground milling machine is also aimed in particular at determining the distance traveled by the ground milling machine during the milling operation as accurately as possible, at least after the milling operation, based on several sensor devices with comparatively little equipment.

A step a) of the method according to the invention may comprise carrying out a milling task along an actual motion path. A milling task in the present case therefore refers, for example, to an operation of the ground milling machine in which the ground milling machine moves along a motion path and mills a ground surface, in particular a road surface, to a milling depth and with a milling width. The resulting milled material may also be removed if necessary. The milling depth and/or the milling width may be constant or vary over the motion path or distance. However, the distance determined using one or more sensors is usually not identical to the actual motion path due to existing measurement tolerances and inaccuracies, but rather represents an assumed motion path of the ground milling machine, which in practice is approximated as closely as possible to the actual motion path.

The method may further comprise, in particular simultaneously with step a), acquiring GNSS position data using a GNSS signal receiving device and creating GNSS position data sets using the acquired GNSS position data and at least one piece of GNSS signal quality information characterizing the accuracy of the GNSS position data contained in the respective GNSS position data set. GNSS (global navigation satellite system) refers to a system for determining a position by receiving signals from navigation satellites. GNSS position data refers to position data obtained using a GNSS signal receiving device carried by the ground milling machine and correspondingly comprising coordinates, i.e., geographical coordinates, in particular for latitude and longitude, for one or more positions. By definition, a single GNSS position data set comprises in particular exactly one position.

A piece of GNSS signal quality information characterizing the accuracy of the GNSS position data contained in the respective GNSS position data set refers to information beyond the actual GNSS coordinates, in particular regarding the accuracy of the respective GNSS position data. As GNSS signal quality information or as a measure of the accuracy of a position defined by GNSS position data, the circular error probability (CEP) may be used, for example, which describes the circular normal distribution of a circle or a circle of probable error that describes the accuracy of the GNSS signal. This may, for example, involve specifying how large the radius/diameter of a circle, in particular a horizontal circle, is in relation to a center point of this circle, within which the actual position is located with an assumed percentage probability, for example 50%. Ultimately, the CEP therefore represents an indication of a probability distribution. This information can thus be used to characterize the accuracy of position information given by GNSS position data. Parameters that may influence the accuracy of GNSS position data may be, for example, a number of satellite signals currently received during positioning, a respective signal strength, a satellite geometry, obstacles such as terrain elevations, buildings and/or trees, signal reflections, meteorological phenomena, etc. The more blatant and/or the larger the number of these potential impairments of the GNSS signal reception quality existing at the GNSS signal receiving device, the worse the quality and thus the accuracy of a position defined by GNSS position data. As GNSS signal quality information or as a measure of the accuracy of a position defined by GNSS position data, other statistical indicators may also be used additionally or alternatively, such as RMS (root mean square) and 2 RMS, which indicate how many measurements are within certain accuracy ranges. The DOP (dilution of precision) value, which describes the quality of the satellite geometry and can be interpreted as the ratio of the position error to the range error, may also be part of this data. Other possible information includes the elevation mask (the angle above the horizon starting at which satellite signals are used), and/or information on absolute and relative accuracy. The absolute accuracy indicates how much the measured position deviates from the true position, while the relative accuracy describes how well a GNSS sensor can compensate for short-term changes. Finally, the configuration of the GNSS signal receiving device itself may also be an indicator of the quality of a position detection determined by it.

The individual points or positions defined by GNSS position data may vary in terms of the associated GNSS signal quality information during the course of a milling operation of the ground milling machine, for example due to changing environmental conditions, etc. A large number of GNSS position data recorded successively along an actual motion path of the ground milling machine, each defining individual positions along the motion path, may therefore simultaneously comprise comparatively precisely determined and thus reliable position points and comparatively imprecisely determined and therefore less reliable position points. This can lead to a situation where a motion path of the ground milling machine derived solely based on GNSS position data deviates comparatively heavily from the actual motion path of the ground milling machine.

The method according to the invention may therefore also comprise a step c) of acquiring position change information of the ground milling machine with the aid of a local motion detection sensor device of the ground milling machine and creating GNSS-independent local position data sets of the ground milling machine from the position change information. In addition to local position data, each local position data set may comprise at least one piece of local position data quality information characterizing the quality of the local position data contained in the respective local position data set. In contrast to the GNSS position data, for the acquiring of which references external to the ground milling machine, specifically defined by satellites, are used, or an absolute determination of the position of the ground milling machine at a specific point in time, it is possible for the local position data sets to be determined independently of a reference to GNSS satellites and even independently of a reference located outside the ground milling machine and, in particular, to be determined exclusively from motion of the ground milling machine itself on the ground milling machine, i.e., locally on or in the ground milling machine itself. Starting from a given starting position, this enables a relative detection of a position change from motion information determined on the ground milling machine itself. In the present case, local is therefore also to be understood in particular as meaning that the position data is determined based on one or more status and/or operating parameters and/or changes in one or more status and/or operating parameters of the ground milling machine, in particular tracked over time. The one or more operating parameters may be, for example, an advance speed, a steering angle, a number of revolutions of one or more travel units, an acceleration, etc. and/or changes thereof. These parameters and/or parameter changes can be determined, monitored and/or detected over time using one or more sensors, for example. However, the local position data sets may also be subject to inaccuracies due to various uncertainty factors, for example due to a temporal and/or local distance from the given starting position to which the parameters and/or parameter changes relate, due to sensor inaccuracies, due to operating conditions, such as a slippery road surfaces, due to slippage occurring at one or more of the travel units during traveling operation, etc. Since the position defined by a local position data set may also depend on the given starting position, the accuracy of the position defined by a local position data set may increase with increasing time offset and/or increasing distance traveled. Based on, for example, one or more such uncertainty factors, respective local position data quality information may also be assigned to each position defined by local position data and may be combined with the respective local position data, in particular for exactly one position, in a local position data set.

Steps b) and c) thus provide two different position data sets obtained in different ways (once with reference to an external reference system, i.e., using GNSS signals, corresponding to direct positioning, and once with reference to indirect positioning or a position derivation performed on, and obtained from the motion behavior of, the ground milling machine), the individual position points of which are associated with respective quality information. In particular, the quality information may therefore be an indication of how accurate the position defined by the respective position data set is.

Based on this, a step d) comprises determining the assumed motion path traveled by the ground milling machine taking into account the GNSS position data sets and the local position data sets by an evaluation device. In order to determine the final assumed motion path, the evaluation device may thus make use of at least the two different position data sets, which may ultimately comprise also including the position data quality information contained in the two position data sets in the final determination of the assumed motion path. This makes it possible, for example, to isolate those positions from the GNSS position data sets and from the local position data sets that are of a higher quality and/or of the highest quality for the assumed motion path traveled, in particular with regard to a time of their respective acquisition that is identical or at least close in time to each other. As a first essential aspect, the method may thus comprise directly or indirectly transmitting, via a wireless and/or wired connection, the information from steps b) and c) to the evaluation device, so that the evaluation device simultaneously has both the local position data sets and the GNSS position data sets to determine an assumed motion path of the ground milling machine. In the evaluation device, the local position data sets and the GNSS position data sets may be merged and/or compared and/or weighed by the evaluation device, etc., as explained in more detail below.

An intermediate step between steps b) and/or c) and step d) may comprise at least temporarily storing the information, i.e., the GNSS position data sets and the local position data sets, from steps b) and c) in a memory device. It is therefore possible that step d) is not necessarily carried out during a running milling operation of the ground milling machine, but only takes place, for example, when an end point of a milling track is reached and/or a traveling operation of the ground milling machine is stopped and/or an evaluation mode of the evaluation device is activated, etc. For this purpose, the GNSS position data sets and local position data sets stored in the memory device may be retrieved from the memory device by the evaluation device.

The GNSS position data sets and/or the local position data sets may be acquired and/or created in steps b) and c) in a time-dependent, and in particular mutually coordinated, manner. Herein, time-dependent acquiring and/or creation refers to acquiring and/or creating the GNSS position data sets and/or the local position data sets in a timed manner. This may, for example, refer to acquiring the GNSS position data and/or local position data at regular intervals and creating the local position data sets and/or GNSS position data sets at regular intervals. It may be ideal if acquiring and/or creating are performed in a time-coordinated manner such that at least the acquiring of the GNSS position data and the local position data is synchronized with each other or performed at least partially, ideally regularly and particularly preferably always, simultaneously, so that GNSS position data and local position data of the ground milling machine are simultaneously available for the respective recording time. This may be controlled by the evaluation device, for example.

The time interval between the acquisition of individual GNSS position data and/or local position data may be constant over the entire milling operation of the ground milling machine. GNSS position data sets and/or local data sets that are based on this position data can then be created accordingly, ideally also at regular time intervals. However, it may be advantageous if the method proceeds such that a time interval for time-dependent acquiring and/or creation in steps b) and c) is dynamically variable or changes over the period of the milling operation, for example to adapt to operating situations in which a determination of a motion path is less precise or more precise. For example, it is possible that during straight-ahead travel, the time interval for acquiring the GNSS and/or local position data and/or for creating the GNSS and/or local position data sets starting from a recorded starting point, defined in particular by at least one GNSS position data set, may also acquire no GNSS position data and/or no local position data at all and/or no GNSS and/or no local position data sets are created, as comparatively few deviations occur during straight-ahead travel. During turns, on the other hand, the situation may be quite different, as the probability that the actual motion path of the ground milling machine deviates from a predefined motion path can increase due to slippage occurring at the travel units, for example. If, for example, a turn is initiated starting from straight-ahead travel, for example as determined via a steering angle sensor and/or actuation of a steering device and/or steering command input device, then local position data and/or GNSS position data may be acquired at shorter time intervals and/or local position data sets and/or GNSS position data sets may be determined at shorter time intervals. Additionally or alternatively, the time intervals may also be shortened, for example, if the current GNSS signal quality information is comparatively good or, for example, the accuracy of the GNSS position signal is comparatively high and vice versa.

Instead of or in addition to time-dependent intervals, it is also possible to provide distance-dependent intervals. This can also include dynamically variable distance intervals, for example depending on one or more of the criteria mentioned above for time-dependent acquiring.

In particular, in order to be able to better relate different GNSS position data sets and/or local position data sets to one another and/or compare them with one another, it may be advantageous if each GNSS position data set and/or each local position data set is assigned, or includes, a timestamp. For this purpose, the ground milling machine may comprise one or more timers, for example. In particular, the respective time stamp may be linked to the respective GNSS position data set and/or local position data set such that it corresponds to the time at which the respective local position data and/or GNSS position data was acquired. The time stamp may be an absolute time indication or also a relative time indication, for example in the form of a time difference from the start of a milling operation and/or the acquisition of previous local and/or GNSS position data or the like. The time stamp may be added to the respective local position data and/or GNSS position data by the evaluation device, the GNSS signal receiving device and/or the motion detection sensor device.

With regard to the specific data acquired in step c), there are various possibilities, wherein the aim is preferably being able to derive a motion path of the ground milling machine, in particular relative to a defined starting point, from the parameters measured on the ground milling machine and its elements themselves by the motion detection sensor device. For this purpose, the ground milling machine may in particular comprise one or more suitable sensors as part of the motion detection sensor device, which detects position and/or adjustment parameters, in particular in absolute and/or relative terms, of one or more of the devices defining the motion of the ground milling machine relative to the underlying ground.

Specifically, this may include, for example, detecting steering instructions. For this purpose, the motion detection sensor device may, for example, have one or more travel and/or position sensors that can be used to determine the travel and/or adjustment positions of one or more control elements, which may be used, for example, by an operator to provide steering instructions, in particular also manually. Such a control element may be a steering lever or a steering wheel, for example. Additionally or alternatively, one or more steering angle sensors may also be provided on one or more elements of an at least partially mechanically acting steering device, which directly or indirectly detect a current steering angle of one or more travel units, for example relative to the machine frame. For example, one or more displacement measuring devices may be included which detect the adjustment position of one or more steering actuators, in particular, for example, steering hydraulic cylinders.

Additionally or alternatively, step c) may also involve detecting a distance. This may be done, for example, by determining the number of revolutions of one or more travel units and/or one or more rotating elements of the ground milling machine corresponding to these, for example with the aid of a speed sensor, within a known and/or defined time window.

Additionally or alternatively, step c) may also include detecting a travel speed and/or accelerations, for example to measure the extent of a distance traveled within a time window. For this purpose, the ground milling machine may have one or more travel speed sensors and/or acceleration sensors.

Additionally or alternatively, step c) may comprise detecting travel motions using one or more inertial sensors.

Additionally or alternatively, it is also possible that step c) comprises detecting travel motions using camera images. For this purpose, the ground milling machine may have one or more cameras and motion of the ground milling machine relative to the underlying ground may be determined by comparing several consecutively recorded camera images using suitable image processing software.

Due to the fact that quality information is available for both the GNSS position data and the local position data, in particular, for example, accuracy information characterizing the respective accuracy of the respective position data, step d) may comprise weighting the GNSS position data and the local position data taking into account the GNSS signal quality information and/or the local position data quality information. In particular, this can mean that pairs of individual simultaneous or at least closely spaced GNSS position data sets and local position data sets can be weighed against each other by the evaluation device to determine the assumed motion path traveled, in particular using predefined weighing criteria.

This can mean, for example, that of pairs of a GNSS position data set and a local position data set, for example acquired simultaneously or at least close in time to each other, for determining the assumed motion path, the evaluation device selects and further takes into account the position data set that has a better quality, in particular higher accuracy, compared to the other position data set. This form of selecting a position data set from a pair with a GNSS position data set and with a local position data set, or a respective elimination of one of the two data sets, may be carried out by the evaluation device in particular if, for example, the quality information of one of the two position data sets is outside a defined range and/or above and/or below a defined threshold and/or, for example, a quotient of the respective quality information is above or below a defined limit value. In this case, the evaluation device thus selects the qualitatively better, in particular more accurate, position data set from a pair of a GNSS position data set and a local position data set.

Additionally or alternatively, step d) may comprise, by the evaluation device, determining estimated position data taking into account the GNSS position data sets and the local position data sets, in particular taking into account and/or depending on their respective quality information. Herein, estimated position data refers in particular to position data that is not based directly on a measurement of a position or a change in position or an operating and/or status parameter, such as the GNSS position data and the local position data, but is determined taking into account both the local position data and the GNSS position data. In addition to a position described by a position data set and a GNSS position data set, the estimated position data can thus define a third position. This position may be identical to a position defined by a GNSS position data set and/or by a local position data set or at least identical with regard to a maximum position probability, or it may also be an additional, third position that differs from the positions defined by the GNSS position data set and/or by the local position data set. The respective quality information of the GNSS position data sets and local position data sets jointly taken into account to determine estimated position data of a way point may be included by the evaluation device, for example, in such a way that the positions defined by the respective GNSS position data set and local position data set together with their respective quality information, in particular, for example, probability distributions, are superimposed with one another and the resulting position point with the highest joint probability is assumed to be the position of the ground milling machine defined in the estimated position data at the respective time. This can be done mathematically using one of the following approaches, for example: A weighted average of the respective position defined by a GNSS position data set and the respective position defined by a local position data set may be obtained. For example, the weighting may be given by a function which, based on the respective quality information, determines two non-negative weights that add up to 1 such that the higher the quality of the GNSS position data set according to the corresponding quality information, the greater the first weight, and such that the higher the quality of the local position data set according to the corresponding quality information, the greater the second weight. The resulting position point can then be determined as the correspondingly weighted sum of the coordinates from the two position data sets. If, for example, the respective quality information contains values σG and σL for the respective probability distribution, wherein, for example, it is assumed for the respective covariance matrix ΣG and ΣL of the respective probability distribution that 93 G=σG2*I and ΣL =σL2*I, where I denotes the two-dimensional unit matrix, and if the coordinates according to the GNSS position data set are denoted by x and the coordinates according to the local position data set are denoted by y, the coordinates of the estimated position data can be defined, for example, as (σL2*x+σG2*y)/(σG2+σL2). The probability distributions may be circular two-dimensional normal distributions, for example. The estimated position may, for example, be determined using a maximum likelihood estimation. This approach may also be used for various other probability distributions. It may also happen that the corresponding maximum likelihood estimator falls outside the range bounded by the two endpoints.

The assumed motion path traveled by the ground milling machine may be determined by the evaluation device in step d) exclusively based on estimated position data from the evaluation device or based on a combination of estimated position data and GNSS and/or local position data. The evaluation device therefore does not necessarily always have to use way points defined by estimated position data for each way point of an assumed motion path defined by several way points, for example, but may also take into account way points defined by only GNSS position data and/or only local position data in addition to way points defined by estimated position data. This may be useful, for example, if, for a pair of a local position data set and a GNSS position data set, i.e., for pairs of position data sets whose GNSS position data and local position data were acquired simultaneously or at least comparatively close to each other in time, the evaluation by the evaluation device shows that one of the two position data sets is incorrect. An error in a position data set may be assumed, for example, if one or more of the sensors fail at least temporarily or if changes in the position of the ground milling machine are determined that are impossible and/or implausible, such as a change in position in a reverse direction if the ground milling machine has only moved in a forward direction or has only been driven in a forward direction. An error in one or more of the GNSS position data and/or local position data may also be assumed, for example, if one or more of the sensors, in particular the motion detection sensor device, determine measured values that are outside a defined measurement range and/or above and/or below a defined threshold value, etc. In particular, for the GNSS signal receiving device, an error may be assumed, for example, if the number of satellite signals received is below a defined minimum number and/or if jumps occur in positions defined by two, in particular temporally consecutive, GNSS position data that are impossible, such as an offset of the position of the ground milling machine over unrealistic distances and/or in directions that would be basically impossible to achieve given the architecture and design of the respective ground milling machine.

The assumed motion path traveled by the ground milling machine may be determined at least partially based on the estimated position data. If both the GNSS position data and the local position data are acquired in a mutually coordinated manner, it is advantageous for each acquisition time to be assigned exactly one position defined either by estimated position data, GNSS position data or local position data as part of the evaluation by the evaluation device. This means that, ideally, the evaluation device may initially have three positions available for determining the assumed motion path of the ground milling machine for each way point of the motion path of the ground milling machine as defined, for example, by an acquisition time for the GNSS position data and the local position data, that is one position defined by the GNSS position data, one position defined by the local position data and one position defined by the estimated position data. Based on, for example, one or more of the above criteria, a selection may now be made by the evaluation device for each of these way points, and the resulting plurality of way points may finally be used to determine the assumed motion path traveled by the ground milling machine. For example, the position defined by the estimated position data could always be used. Alternatively, a decision may be made depending on predefined limit values: For example, if the distance of the position defined by the estimated position data to the corresponding position defined by the GNSS position data is greater than the corresponding distance to the corresponding position defined by the local position data by a factor K, the position defined by the local position data could be used. For example, K could be 2, 3, 4, 5, 6 or a value other than 2. This would be advantageous in that outliers associated with a high degree of uncertainty would not distort the result. In the other direction, K could be ½, ⅓, ¼, ⅕, ⅙ or another value between 0 and 1.

Just as it is possible to use position data defined by a GNSS position data set and/or a local position data set without determining estimated position data under certain conditions, it is additionally or alternatively possible to define criteria based on which estimated position data is determined by the evaluation device and/or used for further evaluation by the evaluation device. This may be useful, for example, if the respective GNSS signal quality information is outside a defined quality threshold, e.g. the accuracy of a detected GNSS position falls below a defined threshold and/or the radius of a circle of probable error or CEP value exceeds a defined threshold. In particular for such a case, it is also possible, for example, that the starting position used to determine positions defined by local position data is or must be a position defined by GNSS position data whose GNSS signal quality information has a minimum quality. This may be the case, for example, if the accuracy of an acquired GNSS position does not fall below a defined threshold and/or the radius of a circle of probable error or CEP value does not fall below a defined threshold. Additionally or alternatively, it is also possible that the starting position used to determine a position based on local position data is a position defined by GNSS position data that precedes the respective local position data set in time. This may be the immediately temporally preceding GNSS position data set or also a GNSS position data set that is older than the respective local position data set by at least a plurality of existing GNSS position data sets and/or by at least a defined time interval. Again, a selection may be made in terms of quality such that only a GNSS position data set with sufficient accuracy or quality may be used to define a starting position. A corresponding threshold may therefore also be defined for this purpose, for example.

Additionally or alternatively, it is also possible that the method, and in particular step d), only uses estimated position data to determine the assumed motion path traveled if both the GNSS position data and the local position data, i.e., the positions defined by them, in particular for a common defined acquisition time, deviate from each other beyond a defined tolerance range.

The method may proceed such that GNSS position data and/or local position data are ignored by the evaluation device in determining the assumed motion path if they are outside defined maximum difference limits when compared with temporally preceding and/or subsequent position data and/or their quality information is outside a permissible range, as already mentioned above. This may be the case, for example, if certain position data are, at least with a high probability, outliers, as described above.

If at least one or both of the positions defined by a pair of, in particular simultaneously acquired, GNSS position data and local position data are classified as outliers by the evaluation device, for example based on the aforementioned criteria, and are therefore not taken into further consideration for the creation of the assumed motion path, the resulting gap in position data may be filled by interpolation or extrapolation using respective temporally preceding and/or subsequent position data. In this way, in particular at a time when a position defined by GNSS position data and/or by local position data and classified as an outlier has been discarded by the evaluation unit for further consideration, probable substitute positions may be calculated by the evaluation device based on temporally preceding and/or subsequent GNSS position data or local position data and substitute GNSS position data and/or substitute local position data estimated by extrapolation or interpolation. It is further possible that these substitute GNSS position data and/or substitute local position data, or the substitute positions defined by them, are used by the evaluation device to generate estimated position data. Additionally or alternatively, it is also possible that substitute GNSS position data are entered or added manually by an operator, wherein it may be advantageous for outliers to be displayed in an intermediate step and, in particular, for substitute position data to be specified manually based on the displayed outliers. Additionally or alternatively, it may also be possible to generate substitute position data, in particular subsequently, using an external source.

An initialization of step d), in particular also comprising determining estimated position data, may depend on one or more factors. Generally, it is possible to determine an assumed motion path traveled by the ground milling machine at the end of a milling operation, for example for documentation and/or billing purposes. In particular with regard to the creation/calculation of one or more estimated position data, additional or alternative operating events may be defined that can trigger these. Such an event may be, for example, a change in a direction of travel of the ground milling machine, in particular the initiation of a turn from straight-ahead travel or ending a straight-ahead travel during operation, especially during a milling process. Additionally or alternatively, it may also be triggered when a travel motion of the ground milling machine is stopped and/or started from a standing position. Additionally or alternatively, a time and/or distance interval may also be defined, after which a motion path is determined by the evaluation device. Finally, it is also additionally or alternatively possible that the determination of estimated position data and/or an assumed motion path by the evaluation device is triggered in particular by the GNSS signal quality information exceeding and/or falling below a defined threshold and/or leaving a defined range.

It is further possible that the evaluation device is configured such that it will always prioritize GNSS position data sets to determine the assumed motion path unless the quality information contained in one or more GNSS position data sets indicates that the quality of the received GNSS position data is too low. In this respect, the GNSS position data sets may initially be prioritized over the local position data sets by the evaluation device to create the assumed motion path.

The position resulting from the local position data set may be based on operating and/or status parameters, and/or changes thereof, detected over time. Ultimately, the information contained in the local position data set may thus define a displacement of the ground milling machine relative a reference position to another position. The choice of the reference position may vary. For example, the reference position may be the starting position of the ground milling machine when starting the milling operation, which may be measured separately or may be a GNSS position data set. Alternatively, it may also be an undefined zero position without coordinates, for example. In order to create a local position data set during ongoing milling operation, use may be made of at least one or more immediately temporally preceding estimated position data sets and/or one or more temporally preceding and/or subsequent GNSS position data sets, or the zero position.

The actual creation of the assumed motion path may be carried out in various ways. A preferred method for this may be a spline interpolation carried out by the evaluation device taking into account the GNSS position data, the local position data and/or the estimated position data or the positions defined by them as nodes. A selection may thus be made for each path segment or for each measurement time as to whether, in particular taking into account one or more of the selection criteria discussed above, the positions defined by GNSS position data, the positions defined by local position data and/or, if available, the positions defined by estimated position data are selected to create the assumed motion path traveled. In this way, a chain of temporally consecutive position data or positions along the motion path can be obtained, which at least partially have a better quality or higher accuracy than, for example, positions or way points defined solely via GNSS position data sets. This selection may then be used to determine or create the assumed motion path. In terms of its course, the assumed motion path obtained in this way is more likely to be closer to the motion path actually traveled by the ground milling machine than a motion path determined solely based on GNSS position data alone or local position data. Other possible methods are the use of cubic splines or weighted splines, in which different nodes are weighted differently, natural splines, linear or non-linear interpolations, Bézier curves, parametric spline interpolations, which allow the interpolation of curves whose x-values are not strictly monotonically increasing, local weighted regressions or other arbitrary logics that result in a connection of the corresponding coordinates in the corresponding order.

A further aspect of the invention relates to a ground milling machine, in particular a self-propelled ground milling machine, comprising a GNSS signal receiving device and a local motion detection sensor device. The ground milling machine may further comprise an evaluation device configured to carry out the method according to the invention, in particular also to carry out preferred embodiments of the method according to the invention. The GNSS signal receiving device and the local motion detection device may be in signal communication with the evaluation device via one or more signal communication connections and transmit current measurement signals to it. The connection(s) may, for example, be at least partially implemented as a CAN bus system.

The ground milling machine may further comprise one or more elements or devices which may be required to perform one or more of the aforementioned method steps individually or in combination, such as one or more sensors of the motion detection device. In this respect, reference is made to the corresponding information regarding the method.

The ground milling machine may comprise a memory device for storing the GNSS position data sets and the local position data sets. The memory device may, for example, be an electronic storage medium, specifically a hard disk memory. In this case, the evaluation device may be configured such that, in an evaluation mode, it retrieves GNSS position data sets and local position data sets stored in the memory device from the memory device and uses them to create the assumed motion path traveled, in particular using a method according to the invention. The evaluation device may comprise one or more suitable computer programs for this purpose. The advantage of using a memory device may be that pure data recording, in particular of the GNSS position data sets and the local position data sets, is possible during milling operation and no continuous updating of an assumed motion path traveled up to a certain moment is necessary. Furthermore, the memory device allows documentation and at least temporary archiving of this data.

In addition to the sensors already described, for example the motion detection device, the ground milling machine may comprise one or more further sensors which may be used to detect one or more status and/or operating parameters relating to the milling operation itself. These sensors may be, for example, one or more sensors for detecting and/or determining a milling operation, a milling depth and/or a milling width.

The ground milling machine may have a display device configured to display the assumed motion path currently determined by the evaluation device and/or based on GNSS position data sets and/or local position data sets. The evaluation device may be configured such that it displays one or more of these motion paths, in particular also superimposed on one another. It is also possible that the assumed motion path is created during operation of the ground milling machine and is displayed to the operator, in particular continuously updated.

The method described above and the embodiment of a ground milling machine according to the invention, in particular also in the form of one or more of the preferred embodiments described, thus enable robust and comparatively precise positioning or position tracking of a ground milling machine during milling operation in near real time with comparatively little effort. At the same time, with regard to the accuracy of individual positions of the ground milling machine along an actual motion path, higher-quality, i.e., more precise, and more accurate positions and position changes can be determined. Based on this, conclusions can be drawn from the motion path of the ground milling machine, such as the determination of a milling volume for documentation and/or billing purposes or for the coordination of a loading process of milled material produced during the milling operation onto one or more transport vehicles, with comparatively little additional effort and with significantly increased precision. There is no need for a cloud connection. A decision may further be made during operation as to whether GNSS position data sets, local position data sets or estimated position data are to be used at a given time to determine a motion path of the ground milling machine, or which selection from these available position data is appropriate.

### BRIEF DESCRIPTION OF THE DRAWINGS

The invention will be explained in more detail below by reference to the embodiment examples shown in the figures. In the schematic figures:

FIG. 1 is a side view of a ground milling machine and other elements;

FIG. 2 is a schematic diagram of a sensor device and an evaluation device;

FIG. 3 is a top view of a motion path of a ground milling machine;

FIG. 4 is a top view of a motion path based on GNSS position data;

FIG. 5 is a top view of the motion path of FIG. 4 and a motion path based on local position data;

FIG. 6 is an enlarged view of a segment I of FIG. 5 with additions;

FIG. 7 is an enlarged view of a segment II of FIG. 5 with additions;

FIG. 8 is an enlarged view of a segment III of FIG. 5 with additions;

FIG. 9 is a top view of a distribution of estimated position data for the motion paths of FIG. 5;

FIG. 10 is a top view of a motion path assumed based on the estimated position data;

FIG. 11 is a flow chart of a method for determining an assumed motion path; and

FIGS. 12A-D further explain individual aspects of the present description.

### DETAILED DESCRIPTION

Like parts or functionally like parts are designated by like reference numerals in the figures. Recurring parts are not necessarily designated separately in each figure.

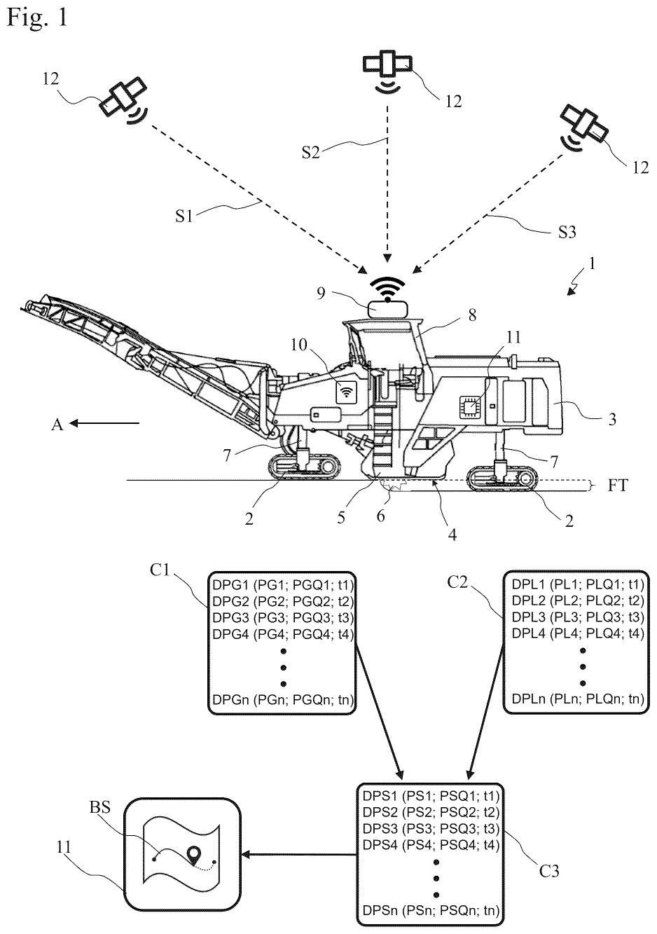

FIG. 1 shows a side view of a self-propelled ground milling machine 1 during milling operation. Elements of the ground milling machine 1 may include, for example, a machine frame 3 supported by travel units 2, in particular wheels and/or crawler tracks, a drive motor not shown in detail in FIG. 1, such as an internal combustion engine and/or electric motor, and a milling device 4 supported in particular by the machine frame 3. The milling device 4 may have a milling drum box 5 and a milling drum 6 at least partially enclosed by the milling drum box 5. The milling drum 6 may, for example, be an essentially hollow-cylindrical support tube with a plurality of milling tools, in particular milling chisels, arranged on its outer surface. The milling device 4 may be connected to the machine frame 3. The machine frame 3 may be connected to the travel units 2 via lifting devices 7, in particular lifting columns, for example. The milling device 4 may further comprise a transport device, possibly comprising several conveyor belts, via which the milled material produced during the milling operation can be transported to a discharge point, for example for loading onto one or more transport vehicles. The ground milling machine 1 may be an autonomous or semi-autonomous ground milling machine 1 or one that is manually controlled by an operator. The ground milling machine 1 may comprise an operator platform 8 from which the ground milling machine 1 can be operated by an operator.

Further elements of the ground milling machine 1 may include a GNSS signal receiving device 9, a motion detection sensor device 10 and/or an evaluation device 11.

The GNSS signal receiving device 9 may be configured to receive satellite signals S (satellite signals S1, S2 and S3 in the example embodiment shown in FIG. 1) from satellites 12 of a GNSS to determine a current position of the ground milling machine 1. The number of satellites 12 from which the GNSS signal receiving device 9 is currently receiving satellite signals S may vary, especially during milling operation of the ground milling machine 1. The more satellite signals S the GNSS signal receiving device currently receives, the more accurately the current position P of the ground milling machine 1 can be determined at a defined measurement time. From the satellite signals S, the GNSS signal receiving device 9 may determine a position Pn, defined for example by longitude and latitude indications, in the form of GNSS position data PGn defining the respective position Pn. Depending on various operating and status constellations of the global navigation satellite system and/or the GNSS signal receiving device 9, such as the number of currently received satellite signals S, the respective signal strength of the received satellite signals S, the current geometric arrangement of the satellites 12 from which satellite signals S are received, etc., the quality, in particular the accuracy, of the GNSS position data PGn may vary.

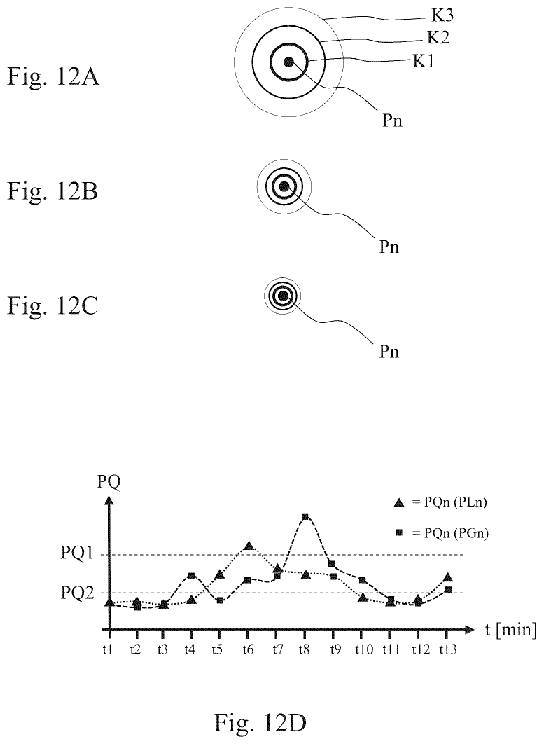

This is illustrated by way of example in FIG. 12 (a), (b) and (c), which each show a top view of a position Pn defined by GNSS position data PGn, comprising in particular a latitude coordinate and a longitude coordinate. Each position Pn is linked to quality information PGQn, which is, for example, information on the accuracy, in particular statistical accuracy, of the respective position Pn. This information may, for example, be an indication of the CEP of the respective position. For example, it may be a variance, standard deviation, covariance matrix, density, distribution function or other information on the probability distribution or the like. FIG. 12 (a) shows a position Pn with a comparatively low accuracy, FIG. 12 (b) with a comparatively medium accuracy and FIG. 12 (c) with a comparatively high accuracy. The circles K1, K2 and K3 around the central point, i.e., around the position Pn assumed with the highest probability may, for example, mark probability limits within which the actual position on which the respective determination of the position P is based is located. The amounts of these probability limits therefore also increase with increasing radial distance to the center point Pn. The smaller the respective circle diameter of the circles K1, K2 and K3, the higher the quality of the respective position Pn, i.e., the more accurate the position information linked to Pn.

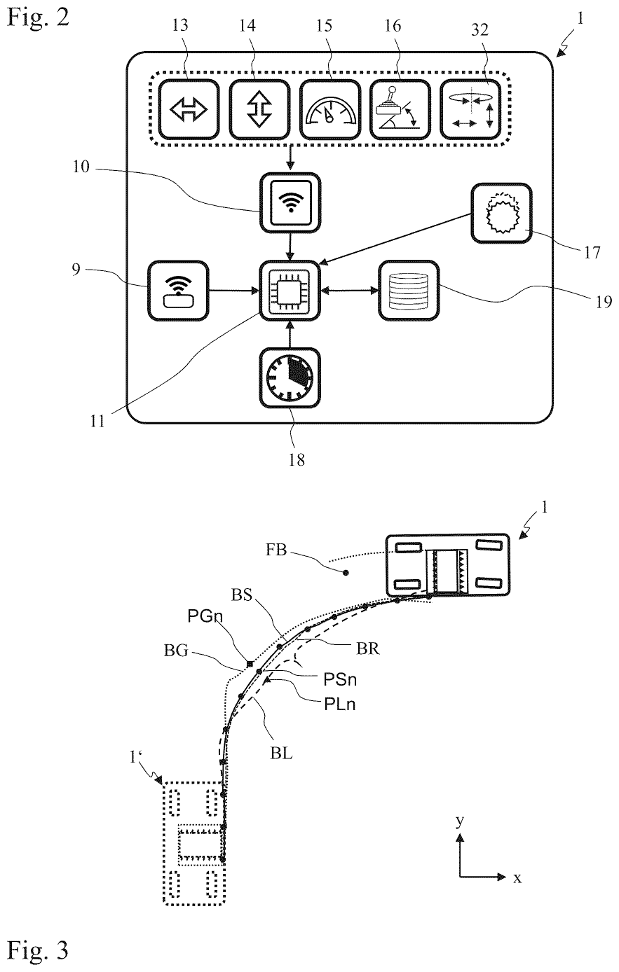

The ground milling machine 1 may further comprise the motion detection sensor device 10. This device may be provided and configured to also determine a position Pn from operating and/or status parameters of the ground milling machine 1 or, in particular, their change over time, but without reference to a global satellite navigation system or to any other reference system external to the ground milling machine 1. Further possible details on the structure of the motion detection sensor device 10 are shown by way of example in FIG. 2, which schematically shows individual components of the ground milling machine 1.

In addition to the GNSS signal receiving device 9 being in signal communication with the evaluation device 11, the motion detection sensor device 10 may also be in signal communication with the evaluation device 11. The motion detection sensor device 10 may comprise one or more sensors, via which individual or several status and/or operating parameters of the ground milling machine 1, in particular positions and/or position changes of elements relating to the travel and/or steering drive and/or the travel and/or steering devices of the ground milling machine 1, can be detected and/or monitored. For this purpose, the motion sensor device 10 may specifically comprise, for example, one or more steering angle sensors 13 and/or direction of travel sensors 14 and/or travel speed sensors 15 and/or lever sensors 16. Additionally or alternatively, the motion sensor device 10 may also comprise one or more travel distance sensors, for example revolution or speed sensors at one or more of the travel units, which are configured to detect a length of a traveled distance. It is also possible, additionally or alternatively, that one or more inertial sensors (IMUs) 32 are provided, in particular also as part of the motion sensor device 10, in order to detect movements and/or changes in direction and/or position of the ground milling machine 1 or at least parts thereof. Such an inertial sensor 32 may, for example, combine different sensor technologies and/or determine, for example, one or more accelerations and/or rotation rates and/or an (earth) magnetic field, in particular its direction, and/or an air pressure, etc.

In addition to the one or more sensors of the motion detection sensor device 10, the ground milling machine 1 may also comprise one or more further sensors which are configured, for example, to detect one or more milling parameters, such as a current milling operation per se and/or a current milling depth and/or width. The one or more sensors are designated as milling sensor 17 in FIG. 2 as an example.

In addition to the elements mentioned, FIG. 2 also shows a time recording device 18 and a memory device 19.

The time recording device 18 may be a device that enables the detection of individual positions and/or position changes, whether with the GNSS signal receiving device 9 or with the motion detection device 10, to be assigned to a specific time. It will be appreciated that the time recording device 18 does not have to be configured as a separate device, but may, for example, already be part of the GNSS signal receiving device 9 or the motion detection device 10. What is important is that it can be used to link individual or multiple position detections and/or position change detections by the GNSS signal receiving device 9 or the motion detection device 10 or to provide position data and/or position data sets with a time stamp. This time stamp may be used, for example, to temporally assign positions created during the course of a motion path of the ground milling machine to one another.

The memory device 19 may be configured for at least temporary storage of data, in particular GNSS position data and local position data described below. These may, for example, be transmitted from the evaluation device 11 to the memory device 19. Conversely, it is also possible that the memory device 19 transmits data stored by it, in particular the aforementioned position data, to the evaluation device 11 or that these can be read out by the evaluation device 11 in the memory device 19.

The elements of the ground milling machine 1 outlined in FIG. 2 may be in wireless and/or wired signal communication with each other via one or more signal communication connections in the described manner. In particular, they may communicate with each other via a CAN bus system provided by the ground milling machine 1.

From the signals of the one or more sensors of the motion detection sensor device 10 or the motion information described thereby, which in particular describe a relative motion with respect to a starting point, the motion detection sensor device 10 creates a position Pn in the form of local position data PLn defining the respective position Pn. This local position data may, for example, include relative changes in longitude and latitude if a reference position defined by longitude and latitude data is available, or describe only relative changes in position with respect to a reference position, for example relative to a starting point of the ground milling machine for the milling operation. The quality, in particular the accuracy, of the local position data PLn may vary depending on the operating characteristics of individual or multiple sensors, for example their respective measurement accuracy and/or functional integrity, and/or various operating and status constellations, such as the current milling depth, the extent of a current steering angle, etc. It is thus possible that each position Pn detected by the motion detection sensor device 10 is also linked in a local position data set DPLn with a local position data quality information PLQn, which may in particular, for example, be a measure of the accuracy of the respective position information, such as a variance, standard deviation, information on the probability distribution or the like.

Thus, in particular during an ongoing milling operation, the ground milling machine 1 may be used to create two collections C1 and C2 of positions or motion points of a ground milling machine 1 moving along an actual motion path, which are based on different acquisition methods, and, for example in the manner explained in more detail below, may be used to create a third collection C3, for example comprising one or more estimated position data PSn. In particular, the respective quality information PGQn of the GNSS position data PGn and PLQn of the local position data PLn at defined times tn may also be taken into account. Based on this third collection C3, the evaluation device 11 may then determine an assumed motion path BS, which is ideally closer to the actual motion path BR than the motion paths BG and BL defined only by the GNSS position data PGn and only by the local position data PLn (illustrated in more detail in the following figures), even if, for example, individual positions Pn could only be acquired with comparatively poor accuracy. This possible procedure indicated in FIG. 1 is explained in more detail in the following figures for explanatory purposes.

FIG. 3 illustrates further details in a top view. The ground milling machine 1 refers to a position of the ground milling machine 1 at the end or completion of a milling operation. The reference numeral 1′, one the other hand, shows the position of the same ground milling machine 1 at the start of milling operation. Accordingly, FIG. 3 only shows an example of the motion path of the ground milling machine 1 partially along a right-hand turn. Along this motion path, the ground milling machine 1 may be in milling operation and mill the ground it passes over at a milling depth FT and over a milling width. In doing so, it may leave a milling bed FB, which for reasons of clarity is indicated in FIG. 3 only for the end position with its side edges.

While the ground milling machine is performing or has performed the motion illustrated in FIG. 3, GNSS position data PGn and local position data PLn may have been acquired and the respective position data sets DPGn and DPLn may have been created. The GNSS position data PGn designate points of a motion path BG, and the local position data PLn designate points of a motion path BL. The motion path assumed taking into account these two motion paths BG and BL as well as the quality information PGQn and PLQn linked to the respective positions Pn, for example by at least partially calculating estimated position data PSn, is designated with BS in FIG. 3. The actual motion path is designated with BR in FIG. 3. FIG. 3 illustrates that the determination of the individual motion paths BG, BL and BS may be based on a large number of position data points, particularly in each case. FIG. 3 shows examples of data points on the motion path BS. However, each of the motions paths BG, BL and/or BS may include a large number of such data points. It is advantageous if each of these data points is assigned quality information Q and, in particular, a time stamp tn (and/or distance information) by means of position data PGn, PLn or PSn, as illustrated in the collections C1, C2 and C3 in FIG. 1. In this way, a plurality of position data PGn, PLn and/or PSn can be sorted by the evaluation device 11, in particular into a chronological sequence, and in particular GNSS position data PGn and local position data PLn which are close together in time or acquired simultaneously can be taken into account together to produce, for example, estimated position data PSn or to select either the respective GNSS position data PGn or the respective local position data PLn using the evaluation device 11 to create the assumed motion path BS, in order to be able to use optimum position data with overall increased quality, in particular accuracy, for determining the assumed motion path BS. Examples of how this can be done are explained in more detail in the following figures, which in each case show segments of the milling path covered by the ground milling machine 1 as shown in FIG. 3.

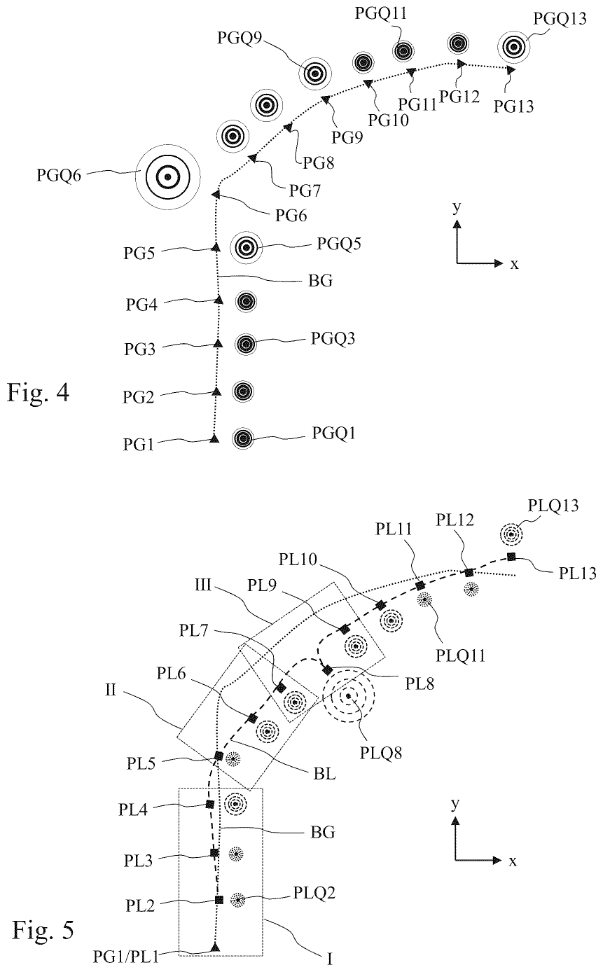

FIG. 4 illustrates the motion path BG acquired solely based on the GNSS position data PGn with the exemplary position data PG1 to PG13 represented by triangles, where PG1 is the start position and PG13 is the end position of the motion path BG. Each individual position defined by the position data PG1 to PG13 is assigned a piece of quality information PGQ1 to PGQ13, in this case quality information PGQn symbolized as circles of probable error (in FIG. 4, for reasons of clarity, only individual pieces of quality information PGQn are designated for some of the positions PGn; however, a respective piece of quality information is shown assigned to each of positions PG1 to PG13). The possible significance of these circles of probable error has already been explained with reference to FIG. 12 (a) to (c), to which reference is made here. Furthermore, again for reasons of clarity, the respective quality information PGQn is not shown in FIG. 4 on the individual positions PG1 to PG13 with the highest probability, but next to them. The larger the radius of the individual circles, the less accurate the position defined in the respective position data PGn and vice versa. The progression of the respective quality information PGQn, in particular accuracy, for example in the form of the variance, of the individual GNSS position data PGn as a function of time is summarized in FIG. 12 (d).

Based on FIG. 4, FIG. 5 also shows the motion path BL, which was created based on the exemplary position data PL1 to PL13, symbolized as squares, which were acquired by the motion detection device 10. The starting point PL1 is used here as the reference point and may be identical to the starting point PG1 for this purpose, for example. Each individual position defined by local position data PLn may again be assigned a piece of quality information PLQn, as again shown in FIG. 5 next to the individual positions defined by the local position data PLn for reasons of clarity. The progression of the respective pieces of quality information PLQn, in particular accuracy, for example in the form of the variance, of the individual local position data PLn is also shown in FIG. 12 (d).

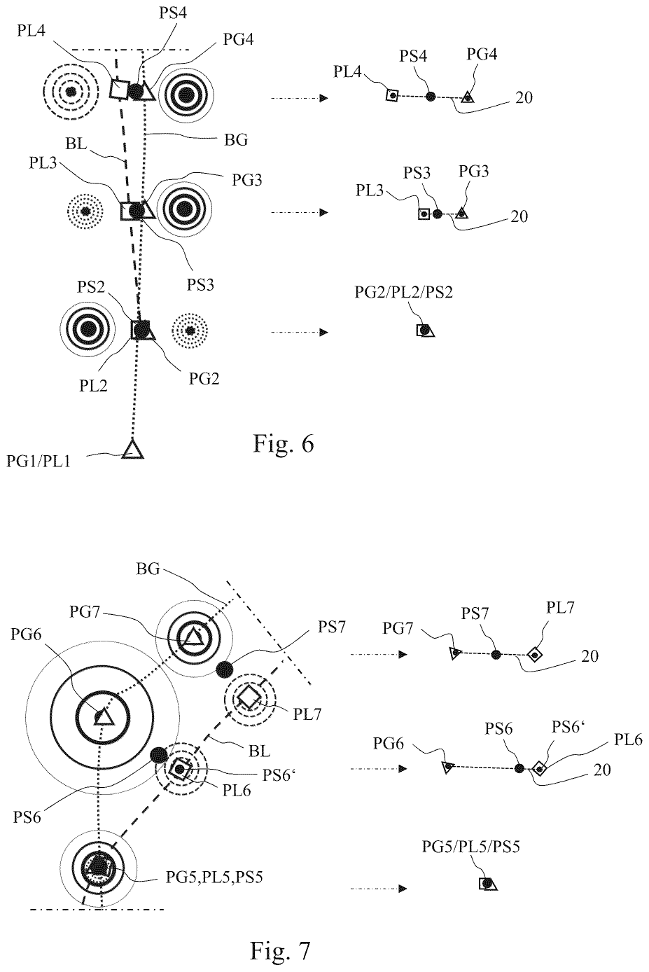

In the illustration according to FIG. 12 (d), position data PLn/PGn at the respective times tn of their acquisition with a comparatively low variance V are therefore of higher quality or better and more precise in terms of their quality or accuracy compared to position data PLn/PGn with a comparatively high variance V. FIG. 12 (d) illustrates that the quality, for example in the form of the variance V, of the respective position data PLn/PGn may fluctuate over the course of a milling operation, for example within the time window t1 to t13. This may be used to weigh the GNSS position data PGn against the local position data PLn with the aid of the evaluation device 11 and/or to determine estimated position data PSn. This is explained by way of example in FIGS. 6, 7 and 8, which each show individual segments of the superimposed turns shown in FIG. 5. FIG. 6 corresponds to segment I in FIG. 5, FIG. 7 corresponds to segment II in FIG. 5, and FIG. 8 corresponds to segment III in FIG. 5.

FIG. 6 shows the superimposition of the respective position data PL1/PG1 to PL4/PG4. PG1 may be not only the oldest position P of the respective motion path or of a milling operation defined by GNSS position data, but also the reference position to which the status and/or operating parameters acquired by the motion detection sensor device 10 are related. Based on this reference position, it is therefore possible to detect how far the ground milling machine 1 has moved and at what steering angle and/or speed. It is possible for this reference position to be updated in the course of a motion path of the ground milling machine 1, for example when a position is determined via the GNSS signal receiving device with comparatively high quality, in particular accuracy/precision.

At the second acquisition time, the positions defined by the GNSS position data PG2 and the local position data PL2 are practically on top of each other. Therefore, estimated position data PS2 does not necessarily need to be determined by the evaluation device at this point. For example, PL2 or PG2 may alternatively be used as the position to be assumed at this time.

FIG. 6 illustrates that in the present example embodiment, the motion paths BG and BL then increasingly drift apart. At the time of recording PL3/PG3, the local position data PL3 compared to the GNSS position data PG3 have a better quality, in particular higher accuracy, than the GNSS position data PG3. As such, it may then be advantageous if the local position data PL3 are also weighted higher than the GNSS position data PG3 for determining estimated position data PS3 by the evaluation device 11, as shown, for example, by the illustration on the right-hand side, where the position defined by the estimated position data PS3 is closer to the position defined by the local position data PL3 on a connecting straight line 20 between the two positions defined by the GNSS position data PG3 and the local position data PL3. For example, the estimate may be in the form of a weighted average of two points, wherein a higher uncertainty of one point contributes to a lower weight and vice versa.

The position data sets recorded at time “4”, on the other hand, are of approximately the same quality. In this case, the position estimated by the estimated position data PS4 may be essentially centered between PL4 and PG4, in particular on a connecting straight line. When finding the point with the joint highest probability from a GNSS position data set and a local position data set, said point does not necessarily need to be a point on a straight line connecting the respective highest probabilities. There may also be distributions other than circular normal distributions, for example linear asymmetric, elliptical, non-circular normal distributions or other distributions. In these cases, the point of joint highest probability may also lie somewhere other than on a direct connecting line.

A further possibility for determining an estimated position or estimated position data PSn in the event that the GNSS position data PGn or the local position data PLn have comparatively poor quality information, in particular accuracy, is illustrated in more detail in FIG. 7. There, for example, the quality of the GNSS position data PG6 decreases abruptly from measuring point PG5/PL5/PS5 and improves again at PG7. In contrast, the quality of the local position data PL6 and PL7 is better than PL5/PG5, i.e., these two position data PL6 and PL7 are particularly more accurate than PL5. In this case, the position estimated by the estimated position data PS6 may be significantly closer to PL6 or even, as indicated by PS6′, be estimated to be equal to PL6. The latter may, for example, be carried out by the evaluation device 11 if the accuracy of the respective position data PGn/PLn falls below a defined threshold value or, for example, the variance exceeds a defined threshold.

Such a threshold PQ1 is shown as an example in FIG. 12 (d). Furthermore, an additional or alternative threshold PQ2 is defined in FIG. 12 (d). This threshold may be used, for example, to specify that, if the GNSS position data PGn are sufficiently accurate or of sufficient quality, for example have a variance V that is less than the defined threshold PQ2, only the respective GNSS position data PGn at the respective time tn are used and, for example, local position data PLn are taken into account additionally, as explained above, only if the quality of the respective GNSS position data is comparatively inferior.

Another possible situation is shown as an example in FIG. 8, which illustrates the occurrence and possible processing of an outlier value by the evaluation device 11. The GNSS position data sets PG7, PG8 and PG9 have a comparable level of quality, in particular accuracy. With regard to the local position data, however, there is a comparatively large offset between PL7 and PL9 and PL8 compared to the local position data PL7 and PL9 adjacent to PL8, both in the progression of the path curve BL and, for example, with regard to the quality information PLQ. This offset may be handled, for example, based on a plausibility check carried out by the evaluation device 11, which checks, for example, whether or not a curve radius detected with a path curve BL would be possible in the first place. If one or more position data are identified as implausible by the evaluation device, in particular if they are simultaneously paired with inferior quality information, the evaluation device 11 may disregard this position data and replace it, for example, with position data obtained by interpolation, as shown in FIG. 8 with the position data PL8′ (replacing PL8) as an example.

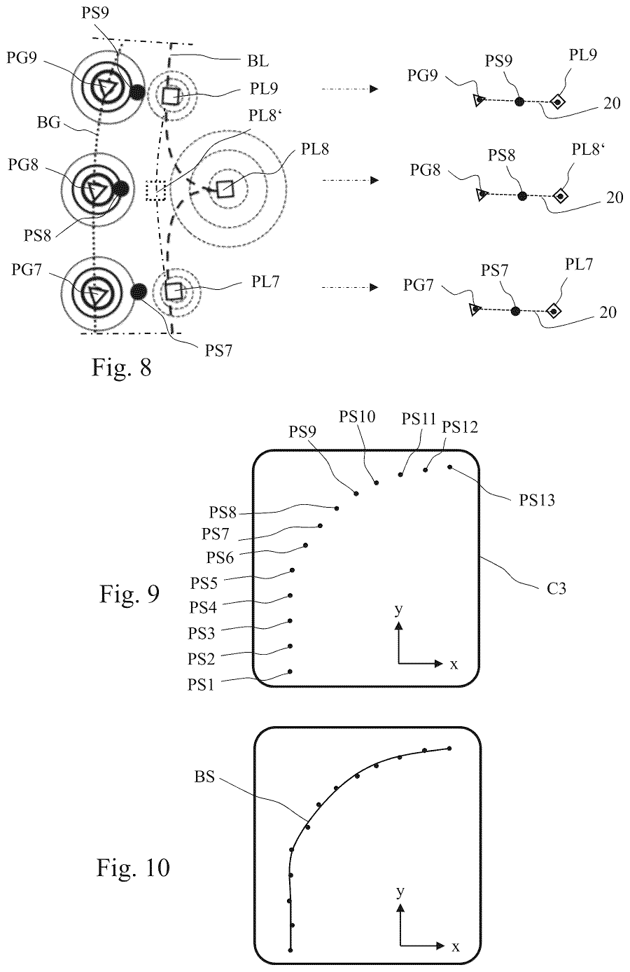

Estimated position data PSn can thus be determined by the evaluation device over the entire milling path or milling section, for example as explained above by way of example, and can be arranged chronologically, for example, as shown in FIG. 9.

The large number of individual points obtained in this way may then be used to obtain the assumed motion path BS based on the estimated position data PSn, for example by interpolation, in particular spline interpolation, as illustrated in FIG. 10.

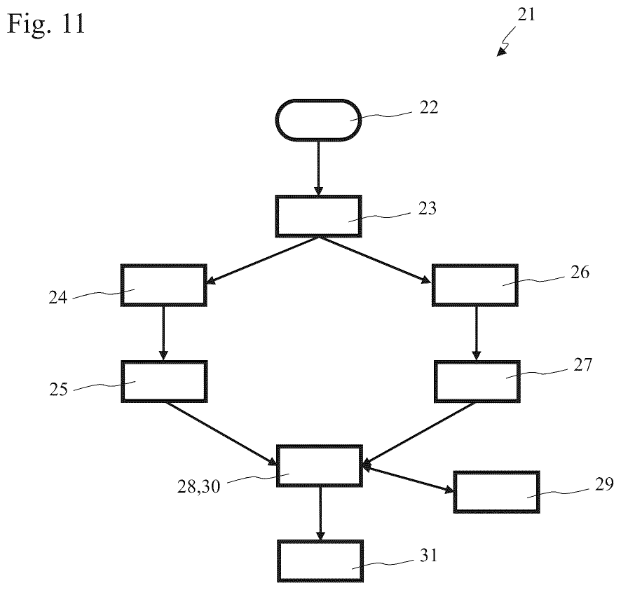

FIG. 11 illustrates possible steps of a method 21 for determining an assumed motion path BS of a ground milling machine 1, in particular with reference to the preceding discussion.

The method 21 may start, for example, by starting 22 a milling operation, or may be started manually. During milling operation, a milling task is carried out 23 along an actual motion path. The ground milling machine thus travels a distance corresponding to the actual motion path BR during milling operation while milling the underlying ground, for example at a milling depth FT.

After starting the milling operation, or during the milling operation, the method may comprise acquiring 24 GNSS position data with the aid of the GNSS signal receiving device 9 and creating 25, using the acquired GNSS position data PGN, GNSS position data sets DPGn and at least one piece of GNSS signal quality information PGQn characterizing the quality or accuracy of the GNSS position data PGn contained in the respective GNSS position data set DPGn, for example also by the GNSS signal receiving device 9.

Furthermore, in particular parallel to at least step 24, the method may comprise acquiring 26 position change information of the ground milling machine 1 using a local motion detection sensor device 10 of the ground milling machine 1 and creating 27 GNSS-independent local position data sets DPLn of the ground milling machine 1 from the position change information. In addition to local position data PLn, at least one piece of local position data quality information PLQn characterizing the quality of the local position data PLn contained in the respective local position data set DPLn may be assigned to each local position data set DPLn acquired. Said acquiring 26 may be carried out exclusively locally on the ground milling machine 1 and, for example, comprise detecting steering inputs and/or motions of a steering device of the ground milling machine and/or detecting travel motions of a travel unit of the ground milling machine via one or more suitable sensors of the motion detection sensor device 10. It is ideal if the motion detection sensor device 10 is configured such that it does not require any use of one or more references localized externally to the ground milling machine 1.

Based on the position data sets DPLn and DPGn acquired and determined during milling operation as described above, the method may finally comprise, by the evaluation device 11, determining 28 the assumed motion path BS of the ground milling machine taking into account the GNSS position data sets DPGn and the local position data sets DPLn. This step may comprise various operations. Step 28 may, for example, include weighting 29 the GNSS position data PGn and the local position data PLn taking into account the GNSS signal quality information PGQn and/or the local position data quality information PLQn, in particular, for example, as described above. Step 28 may in particular also comprise determining 30 estimated position data PSn taking into account the GNSS position data sets DPGn and the local position data sets DPLn by the evaluation device, also in particular as described above by way of example. If the method comprises determining 30 estimated position data PSn taking into account the GNSS position data sets DPGn and the local position data sets DPLn, it is particularly preferred if determining 38 of the assumed motion path BS traveled by the ground milling machine is carried out at least partially based on this estimated position data PSn.

It is possible that only estimated position data PSn is used for determining 28 the assumed motion path BS. However, estimated position data PSn, GNSS position data PGn and/or local position data PLn may also be combined in step 28. For example, one or more exclusion criteria may be defined, according to which one or more GNSS position data sets DPGn and/or local position data sets DPLn are accepted and/or neglected for determining a way point. In particular, individual and/or several of the GNSS position data sets DPGn and/or the local position data sets may be eliminated if the GNSS signal quality information PGQn and/or the local position data quality information is beyond a defined quality threshold and/or a defined range. Additionally or alternatively, it is possible for step 28 that estimated position data PSn are only used to determine the assumed motion path BS if the GNSS position data DPGn and/or the local position data DPLn deviate from each other beyond a defined tolerance range. Additionally or alternatively, GNSS position data and/or local position data may be ignored in determining the assumed motion path BS if they are outside defined maximum difference limits compared to temporally preceding and/or subsequent position data and/or their quality information is outside a permissible range and/or position changes are implausible.

In particular, it is possible that at least steps 24 and 26 are repeated regularly during the milling operation, wherein said acquiring is preferably time-dependent and in particular mutually coordinated. Additionally or alternatively, it may also be distance-dependent, in particular coordinated.

Said time-dependent and/or distance-dependent acquiring in steps 24 and 26 may be performed at regular time and/or distance intervals. However, it is also possible that the time and/or distance intervals provided for acquisition are dynamically variable or are varied over the milling operation depending on one or more operating and/or status parameters. If, for example, the ground milling machine 1 is moving in a straight-ahead direction during milling operation, longer time and/or distance intervals may be sufficient, whereas during turns the frequency for acquiring individual way points may be increased or the distance length shortened in order to increase the density of measuring points available per time unit and/or distance unit for turns, for example, and ultimately to obtain an assumed motion path BS with a higher probability of correspondence to the actual motion path BR of the ground milling machine 1.

In extreme cases, based on the acquisition of initial GNSS position data when starting a milling operation, it is possible that local position data DPLn is only generated in step 27 and taken into account in step 28 upon occurrence of a first deviation from straight-ahead travel. In particular also in order to be able to monitor and detect this movement behavior of the ground milling machine 1, it is also possible that a detection of steering instructions and/or motions of a steering device of the ground milling machine and/or a detection of travel motions of a travel device of the ground milling machine takes place and is taken into account accordingly by the evaluation device 11. Accordingly, it is also possible that the determination 28 taking into account local position data PLn only takes place when a change in a direction of travel of the ground milling machine occurs and/or straight-ahead travel no longer continues and/or a travel motion of the ground milling machine is stopped.

The assumed trajectory may be determined 28, for example, using spline interpolation taking into account the GNSS position data, the local position data and/or estimated position data as nodes.

The assumed motion path BS of the ground milling machine 1 determined in step 28 may then be displayed in a step 31, for example, and/or used to calculate a milling output.

### LIST OF REFERENCE NUMERALS

1 ground milling machine
2 travel unit
3 machine frame
4 milling device
5 milling drum box
6 milling drum
7 lifting device
8 operator platform
9 GNSS signal receiving device
10 motion detection sensor device
11 evaluation device
12 satellite
13 steering angle sensor
14 direction of travel sensor
15 travel speed sensor
16 lever sensor
17 milling sensor
18 time recording device
19 memory device
20 connecting straight line
21 method for determining
22 start of a milling operation
23 execution
24 acquiring GNSS position data
25 creating GNSS position data sets
26 acquiring local position data
27 creating local position data sets
28 determining an assumed motion path traveled
29 weighting
30 determining estimated position data
31 calculating a milling output
32 inertial sensor
S satellite signal
A forward/milling direction
Pn position
PGn GNSS position data
PGQn GNSS signal quality information
DPGn GNSS position data set
PLn Local position data
PLQn Local position data quality information
DPLn Local position data set
BS assumed motion path
BG motion path defined via GNSS position data
BL motion path defined via local position data
C1 collection GNSS
C2 collection local
C3 collection estimate
PSn estimated position data
FB milling bed
BG motion path from GNSS position data
BL motion path from local position data
BS assumed motion path
BR actual motion path
tn timestamp
V variance
t time
Ft milling depth

What is claimed is:

1. A method for determining an assumed motion path traveled by a ground milling machine, comprising the steps of:
a) carrying out a milling task along an actual motion path;
b) acquiring global navigation satellite system (GNSS) position data using a GNSS signal receiving device and creating GNSS position data sets with the acquired GNSS position data and at least one piece of GNSS signal quality information characterizing the accuracy of the GNSS position data contained in the respective GNSS position data set;
c) acquiring position change information of the ground milling machine using a local motion detection sensor device of the ground milling machine and creating GNSS-independent local position data sets of the ground milling machine from the position change information, wherein each local position data set comprises, in addition to local position data, at least one piece of local position data quality information characterizing the quality of the local position data contained in the respective local position data set;
d) determining the assumed motion path of the ground milling machine taking into account the GNSS position data sets and the local position data sets by an evaluation device, wherein GNSS position data and/or local position data are ignored in determining the assumed motion path if:
they are outside defined maximum difference limits compared to temporally preceding and/or subsequent position data; and/or
their quality information is outside a permissible range.

2. The method according to claim 1, wherein said acquiring in steps b) and c) is performed in a time-dependent manner, in particular in a mutually coordinated manner.

3. The method according to claim 1, wherein said time-dependent acquiring in steps b) and c) is dynamically variable.

4. The method according to claim 1, wherein said acquiring in step c) comprises at least:
detecting steering instructions and/or motions of a steering device of the ground milling machine;
detecting travel motions of a travel unit of the ground milling machine;
detecting travel motions using inertial sensors;
detecting travel motions using camera images.

5. The method according to claim 1, wherein step d) comprises weighting the GNSS position data and the local position data taking into account the GNSS signal quality information and/or the local position data quality information.

6. The method according to claim 1, wherein step d) comprises determining estimated position data by the evaluation device taking into account the GNSS position data sets and the local position data sets, and in that said determining of the assumed motion path of the ground milling machine is carried out at least partially based on the estimated position data.

7. The method according to claim 1, wherein estimated position data is determined and/or used for further evaluation by the evaluation device only if the GNSS signal quality information is beyond a defined quality threshold.

8. The method according to claim 1, wherein estimated position data are used for determining the assumed motion path only if the GNSS position data and the local position data deviate from each other beyond a defined tolerance range.

9. The method according to claim 1, wherein step d) is initialized if:
a change of a direction of travel of the ground milling machine occurs; and/or
a straight-ahead travel no longer continues; and/or
a travel motion of the ground milling machine is stopped; and/or
a defined time and/or distance interval has elapsed; and/or
the GNSS signal quality information exceeds or falls below a defined threshold and/or leaves a defined range.

10. The method according to claim 1, wherein at least one immediately temporally preceding estimated position data set or GNSS position data set is used to create a local position data set.

11. The method according to claim 1, wherein creating the assumed motion path is carried out using spline interpolation taking into account the GNSS position data, the local position data and/or estimated position data as nodes.

12. A ground milling machine comprising a GNSS signal receiving device and a local motion detection sensor device, wherein it has an evaluation device for carrying out the method according to claim 1.

13. The ground milling machine according to claim 12, wherein it comprises a memory device for storing the GNSS position data sets and the local position data sets, and in that the evaluation device is configured such that in an evaluation mode it retrieves GNSS position data sets and local position data sets stored in the memory device from the memory device and uses them to create the assumed motion path.
